(19) United States
(12) Patent Application Publication
(10) Pub. No.: US 2025/0030512 A1
(43) Pub. Date: Jan. 23, 2025

(54) CONFIGURED GRANT FOR MULTI-PANEL UPLINK TRANSMISSION

(71) Applicant: Telefonaktiebolaget LM Ericsson (publ), Stockholm (SE)

(72) Inventors: Siva Muruganathan, Stittsville (CA); Andreas Nilsson, Göteborg (SE); Shiwei Gao, Nepean (CA); Claes Tidestav, Bålsta (SE)

(21) Appl. No.: 18/708,440

(22) PCT Filed: Nov. 9, 2022
(86) PCT No.: PCT/EP2022/081317

§ 371 Date: May 8, 2024

Related U.S. Application Data
(60) Provisional application No. 63/277,394, filed on Nov. 9, 2021.

(51) Int. Cl. H04L 5/00; H04W 72/1268

(52) U.S. Cl. CPC H04L 5/0035; H04L 5/0053; H04W 72/1268

(57) ABSTRACT

Systems and methods for configured grant for multi-panel Uplink (UL) transmission are provided. In some embodiments, a method performed by a User Equipment (UE) for transmitting PUSCH configured grant to multiple-TRPs includes: receiving a configuration of at least one unified TCI state, indicating mTRP operation; receiving an indication of a configured grant, indicating either mTRP operation using repetition or Simultaneous Transmission Across Multiple Panels (STxMP); and transmitting a PUSCH according to the configuration o. In this way, the unified TCI state framework can be extended to mTRP and multi-panel transmission for configured grant. With the unified TCI state framework, separate spatial relations do not have to be configured for UL transmission. Hence, unified TCI state framework can provide some higher layer overhead savings. By extending unified TCI state framework for mTRP and multi-panel transmission for configured grant, configured grant based PUSCH can also leverage this advantage.

### TECHNICAL FIELD

The current disclosure relates generally to transmitting with multiple-Transmission Reception Points (TRPs).

### BACKGROUND

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:

Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL in NR, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to receive also this signal. Note that for beam management, the discussion mostly revolves around QCL Type D, but it is also necessary to convey a Type A QCL relation for the RSs to the UE, so that it can estimate all the relevant large-scale parameters.

Typically, this is achieved by configuring the UE with a CSI-RS for tracking (TRS) for time/frequency offset estimation. To be able to use any QCL reference, the UE would have to receive it with a sufficiently good SINR. In many cases, this means that the TRS must be transmitted in a suitable beam to a certain UE.

To introduce dynamics in beam and Transmission Reception Point (TRP) selection, the UE can be configured through RRC signaling with up to 128 Transmission Configuration Indicator (TCI) states. The TCI state information element is shown in below (Extracted from 3GPP TS 38.331):

| | |
|---|---|
| TCI-State ::= | SEQUENCE { |
| tci-StateId | TCI-StateId, |
| qcl-Type1 | QCL-Info, |
| qcl-Type2 | QCL-Info |
| ... | |
| } | |
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| ... | |
| } | |

Each TCI state contains QCL information related to one or two RSs. For example, a TCI state may contain CSI-RS1 associated with QCL Type A and CSI-RS2 associated with QCL TypeD. If a third RS, e.g., the PDCCH DMRS, has this TCI state as QCL source, it means that the UE can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates via MAC CE one TCI state for PDCCH (i.e., provides a TCI state for PDCCH) and up to eight TCI states for PDSCH. The number of active TCI states the UE support is a UE capability, but the maximum is 8.

Assume a UE has 4 activated TCI states (from a list of totally 64 configured TCI states). Hence, 60 TCI states are inactive for this particular UE and the UE needs not be prepared to have large scale parameters estimated for those inactive TCI states. But the UE continuously tracks and updates the large scale parameters for the RSs in the 4 active TCI states. When scheduling a PDSCH to a UE, the DCI contains a pointer to one activated TCI state. The UE then knows which large scale parameter estimate to use when performing PDSCH DMRS channel estimation and thus PDSCH demodulation.

As long as the UE can use any of the currently activated TCI states, it is sufficient to use DCI signaling. However, at some point in time, none of the source RSs in the currently activated TCI states can be received by the UE, i.e., when the UE moves out of the beams in which the source RSs in the activated TCI states are transmitted. When this happens (or actually before this happens), the gNB would have to activate new TCI states. Typically, since the maximum number of activated TCI states is fixed, the gNB would also have to deactivate one or more of the currently activated TCI states.

The two-step procedure related to TCI state update is depicted in FIG. 1 which illustrates a two-stage TCI state update. The selected TCI state is selected from the activated set of TCI states using DCI, and the set of activated TCI states is updated using MAC CE.

There currently exist certain challenge(s). TCI states Activation/Deactivation for UE-specific PDSCH via MAC CE

Now the details of the MAC CE signaling that is used to activate/deactivate TCI states for UE specific PDSCH are provided. The structure of the MAC CE for activating/deactivating TCI states for UE specific PDSCH is given in FIG. 2 (TCI States Activation/Deactivation for UE-specific PDSCH MAC CE (Extracted from FIG. 6.1.3.14-1 of 3GPP TS 38.321)).

As shown in FIG. 2, the MAC CE contains the following fields:
Serving Cell ID: This field indicates the identity of the Serving Cell for which the MAC CE applies. The length of the field is 5 bits;
BWP ID: This field contains the ID corresponding to a downlink bandwidth part for which the MAC CE applies. The BWP ID is given by the higher layer parameter BWP-Id as specified in 3GPP TS 38.331. The length of the BWP ID field is 2 bits since a UE can be configured with up to 4 BWPs for DL;
A variable number of fields T: If the UE is configured with a TCI state with TCI State ID i, then the field Tᵢ indicates the activation/deactivation status of the TCI state with TCI State ID i. If the UE is not configured with a TCI state with TCI State ID i, the MAC entity shall ignore the Tᵢ field. The Tᵢ field is set to “1” to indicate that the TCI state with TCI State ID i shall be activated and mapped to a codepoint of the DCI Transmission Configuration Indication field, as specified in 3GPP TS 38.214/38.321. The Tᵢ field is set to “0” to indicate that the TCI state with TCI State ID i shall be deactivated and is not mapped to any codepoint of the DCI Transmission Configuration Indication field. It should be noted that the codepoint to which the TCI State is mapped is determined by the ordinal position among all the TCI States with Tᵢ field set to “1”. That is the first TCI State with 7, field set to “1” shall be mapped to the codepoint value 0 of DCI Transmission Configuration Indication field, the second TCI State with Tᵢ field set to “1” shall be mapped to the codepoint value 1 of DCI Transmission Configuration Indication field, and so on. In NR Rel-15, the maximum number of activated TCI states is 8;
A Reserved bit R: this bit is set to ‘0’ in NR Rel-15.

Note that the TCI States Activation/Deactivation for UE-specific PDSCH MAC CE is identified by a MAC PDU subheader with logical channel ID (LCID) as specified in Table 6.2.1-1 of 3GPP TS 38.321 (this table is reproduced below in Table 1). The MAC CE for Activation/Deactivation of TCI States for UE-specific PDSCH has variable size.

### TCI State Indication for UE-Specific PDSCH Via DCI

The gNB can use DCI format 1_1 or 1_2 to indicate to the UE that it shall use one of the activated TCI states for the subsequent PDSCH reception. The field being used in the DCI is Transmission configuration indication, which is 3 bits if tci-PresentInDCI is “enabled” or tci-PresentForDCI-Format1-2-r16 is present respectively for DCI format 1_1 and DCI 1_2 by higher layer signaling. One example of such a DCI indication is depicted in FIG. 3 (Example of DCI indication of a TCI state. The DCI gives a pointer into the ordered list of activated TCI states).

In the example of FIG. 3, DCI code point 0 indicates the first TCI state index (e.g., TCI 3) in the list of TCI states, DCI code point 1 indicates the second TCI state index (e.g., TCI 7) in the list, and so on.

### Multi-TRP TCI State Operation

In Release 16, multi-TRP (multiple-transmission reception point) operation was specified and it has two modes of operation: single DCI based multi-TRP and multiple DCI based multi-TRP.

In NR Rel-16, multiple DCI scheduling is for multi-TRP in which a UE may receive two DCIs each scheduling a PDSCH/PUSCH. The PDCCH and the PDSCH which is scheduled via the PDCCH are both transmitted from the same TRP.

For multi-DCI multi-TRP operation, a UE needs to be configured with two CORESET pools, each associated with a TRP. Each CORESET pool is a collection of CORESETs that belongs to the same CORESET pool. A CORESET pool index can be configured in each CORESET with a value of 0 or 1. For the two DCIs in the above example, they are transmitted in two CORESETs belonging to different CORESET pools (i.e., with CORESETPoolIndex 0 and 1 respectively). For each CORESET Pool, the same TCI state operation method in terms of activation/deactivation/indication as for described in 2.2-2.3 is assumed.

The other multi-TRP mode, single DCI based mTRP, needs two DL TCI states to be associated to one DCI codepoint in the TCI field in DCI. That is, when a TCI field codepoint in DCI indicates two TCI states, each TCI state corresponds to a different beam or different TRP. The activation and mapping of 2 TCI states for a codepoint in the TCI field of DCI is done with the below MAC CE from 3GPP TS 38.321:

### Enhanced TCI States Activation/Deactivation for UE-Specific PDSCH MAC CE

The Enhanced TCI States Activation/Deactivation for UE-specific PDSCH MAC CE is identified by a MAC PDU subheader with eLCID as specified in Table 6.2.1-1b. An example of this is shown in FIG. 4. It has a variable size consisting of following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in TS 38.212 [9]. The length of the BWP ID field is 2 bits;
Cᵢ: This field indicates whether the octet containing TCI state ID_{i,2} is present. If this field is set to “1”, the octet containing TCI state ID_{i,2} is present. If this field is set to “0”, the octet containing TCI state ID_{i,2} is not present;
TCI state ID_{i,j}: This field indicates the TCI state identified by TOI-StateId as specified in TS 38.331 [5], where i is the index of the codepoint of the DCI Transmission configuration indication field as specified in TS 38.212 [9] and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e., the first TCI codepoint with TCI state ID_{0,1} and TCI state ID_{0,2} shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2.
R: Reserved bit, set to “0”.

### Rel-17 TCI State Framework

In 3GPP Rel-17, a new unified TCI state framework will be specified, which aims to streamline the indication of transmit/receive spatial filter (and other QCL properties) to the UE by letting a single TCI state indicate QCL properties for multiple different DL and/or UL signals/channels.

In meeting RAN1 #103-e it was agreed that the new unified TCI state framework should include a three stage TCI state indication (in a similar way as was described above for PDSCH) for all or a subset of all DL and/or UL channels/signals. In the first stage, RRC is used to configure a pool of TCI states. In the second stage, one or more of the RRC configured TCI states are activated via MAC-CE signaling and associated to different TCI field codepoints in DCI format 1_1 and 1_2. Finally, in the third stage, DCI signaling is used to select one of the TCI states (or two TCI states in case separate TCI states are used for DL channels/signals and UL channels/signals) that was activated via MAC-CE.

In RAN1 #103-e meeting it was agreed to support both joint beam indication (“Joint DL/UL TCI”) and separate DL/UL beam indication (“Separate DL/UL TCI”), as can be seen in the agreements below. For Joint DL/UL TCI, a single TCI state (which for example can be a DL TCI state or a Joint TCI state) is used to determine a transmit/receive spatial filter for both DL signals/channels and UL signals/channels. For Separate DL/UL TCI, one TCI state (for example a DL TCI state) can be used to indicate a receive spatial filter for DL signals/channels and a separate TCI state (for example an UL TCI state) can be used to indicate a transmit spatial filter for UL signals/channels.

### Agreement

On beam indication signalling medium to support joint or separate DL/UL beam indication in Rel. 17 unified TCI framework:
Support L1-based beam indication using at least UE-specific (unicast) DCI to indicate joint or separate DL/UL beam indication from the active TCI states
   The existing DCI formats 1_1 and 1_2 are reused for beam indication
Support activation of one or more TCI states via MAC CE analogous to Rel.15/16:

### Agreement

On Rel-17 unified TCI framework, to accommodate the case of separate beam indication for UL and DL:
Utilize two separate TCI states, one for DL and one for UL.
For the separate DL TCI:
   The source reference signal(s) in M TCIs provide QCL information at least for UE-dedicated reception on PDSCH and for UE-dedicated reception on all or subset of CORESETs in a CC
For the separate UL TCI:
   The source reference signal(s) in N TCIs provide a reference for determining common UL TX spatial filter(s) at least for dynamic-grant/configured-grant based PUSCH, all or subset of dedicated PUCCH resources in a CC
   Optionally, this UL TX spatial filter can also apply to all SRS resources in resource set(s) configured for antenna switching/codebook-based/non-codebook-based UL transmissions
FFS: Whether the UL TCI state is taken from a common/same or separate TCI state pool from DL TCI state

It has further been agreed that for “Joint DL/UL TCI” and for “Separate DL/UL TCI”, DL large scale QCL properties are inferred from one (qcl-Type1) or two RSs (qcl-Type1 and qcl-Type2) analogous to Rel-15/16 TCI state framework. And for “Joint DL/UL TCI”, UL spatial filter is derived from the RS of DL QCL Type D.

URLLC Reliability for mTRP Operation

In NR rel-16 mTRP (multi-TRP) reliability enhancements where specified for PDSCH by repeating PDSCH transmission (using TDM/FDM or SDM) over two different TRPs. In NR Rel-17, URLLC reliability enhancements will be extended also for PUSCH and PUCCH by using TDM repetition from two different TRPs. In order to quickly switch between sTRP (single-TRP) operation (which typically is useful for eMBB applications) and mTRP operation (which typically is useful for URLLC applications), it was agreed to support dynamic switching between these two modes of operation, see agreement below from RAN1 #105e:

### Agreement

Confirm the Working Assumption (with supporting two bits for the new field).
For indicating STRP/MTRP dynamic switching for non-CB/CB based MTRP PUSCH repetition,
   Introduce a new field in DCI to indicate at least the S-TRP or M-TRP operation.
   The new field is 2 bits

### Agreement

For the new field in the DCI for dynamic switching, support Alt. 1 (modified).

Alt.1 Support 2 bits with the following combinations.

| | | SRI (for both CB and |
|---|---|---|
| | | NCB)/TPMI (CB only) |
| Codepoint | SRS resource set(s) | field(s) |
| 00 | s-TRP mode with 1^{st} SRS | 1^{st} SRI/TPMI field (2^{nd} |
| | resource set (TRP1) | field is unused) |
| 01 | s-TRP mode with 2^{nd} SRS | 1^{st} SRI/TPMI field (2^{nd} |
| | resource set (TRP2) | field is unused) |
| 10 | m-TRP mode with (TRP1, | Both 1^{st} and 2^{nd} SRI/TPMI |
| | TRP2 order) | fields |
| | 1^{st} SRI/TPMI field: 1^{st} SRS | |
| | resource set | |
| | 2^{nd} SRI/TPMI field: 2^{nd} SRS | |
| | resource set | |
| 11 | m-TRP mode with (TRP2, | Both 1^{st} and 2^{nd} SRI/TPMI |
| | TRP1 order) | fields |
| | 1^{st} SRI/TPMI field: FFS | |
| | 2^{nd} SRI/TPMI field: FFS | |

The SRS resource set with lower ID is the first SRS resource set, and the other SRS resource set is the second SRS resource set.

In the above agreement, two SRI (SRS resource indicator) fields in DCI are used to indicate the SRS resources corresponding to the two TRPs. The SRS resources in turn provide the spatial relations corresponding to the two TRPs which are used to derive the spatial transmit filter(s) corresponding to the two TRPs. For instance, the first SRI field provides a first spatial relation corresponding to the first TRP which is used to transmit one or more PUSCH transmission occasions (or PUSCH repetitions) corresponding to the first TRP. Similarly, the second SRI field provides a second spatial relation corresponding to the second TRP which is used to transmit one or more PUSCH transmission occasions (or PUSCH repetitions) corresponding to the second TRP. Note that the term TRP may not be specified in 3GPP specifications. Instead, the term SRI may be used in 3GPP specifications which is understood to represent a TRP.

### UL Transmission to Multiple Transmission Points (TRPs)

PDSCH transmission with multiple transmission points has been introduced in 3GPP for NR Rel-16, in which a transport block may be transmitted over multiple TRPs to improve transmission reliability.

In NR Rel-17, it has been proposed to introduce UL enhancement with multiple TRPs by transmitting a PUCCH or PUSCH towards to different TRPs as shown in FIG. 5, in different times (either in different slots or in different sets of symbols within a slots, also known sometimes referred to as subslot or mini-slot). FIG. 5 illustrates an example of PUCCH/PUSCH transmission towards multiple TRPs for increasing reliability.

In one scenario, multiple PUCCH/PUSCH transmissions each towards a different TRP may be scheduled by a single DCI. For example, multiple spatial relations (i.e., spatial beams) may be activated for a PUCCH resource and the PUCCH resource may be signaled in a DCI scheduling a PDSCH. The HARQ A/N associated with the PDSCH is then carried by the PUCCH which is then repeated multiple times either within a slot or over multiple slots, each repetition is towards a different TRP. An example is shown in FIG. 6, where a PDSCH is scheduled by a DCI and the corresponding HARQ A/N is sent in a PUCCH which is repeated twice in time, one towards TRP #1 and the other towards TRP #2. Each TRP is associated with a PUCCH spatial relation. FIG. 6 illustrates an example of a single DCI triggered PUCCH repetitions each towards a different TRP.

An example of PUSCH repetitions is shown in FIG. 7, where two PUSCH repetitions for a same TB are scheduled by a single DCI, each PUSCH occasion is transmitted towards a different TRP. FIG. 7 illustrates an example PUSCH repetitions each towards a different TRP. Each TRP is associated with an SRI or a UL TCI state signaled in DCI. Note that the spatial Transmit filter used to transmit PUSCH repetitions towards a given TRP are provided by the corresponding SRI or UL TCI state.

### Power Control for New Unified DL/UL TCI Framework

In Rel-17, it has been agreed that a set of UL PC parameters (P0, alpha, closed loop index) can be associated with a Joint/UL TCI state (where Joint/UL TCI states are described in Section 2.5). It has also been agreed that there can be two different sets of UL PC parameters per Joint/UL TCI state; one for PUCCH and one for PUSCH. It has also been agreed previously that a PL-RS (path loss reference signal) can be associated with a Joint/UL TCI state. Exactly how the association is configured and signaled to the UE is still under discussions in 3GPP.

### Configured Grant in NR

In addition to dynamic scheduling, semi-persistent scheduling of PUSCH using configured grants (CG) is also supported in NR. There are two types of CG based PUSCH supported in NR, i.e., CG type 1 and CG type 2. In CG type 1 PUSCH, all parameters are configured by RRC, including the periodicity and the time domain offset, resource allocation, MCS, power control parameters (i.e., alpha, P0, closed-loop index, and PL-RS), SRS resource indicator, precoding matrix and number of layers, etc. Hence, CG type 1 PUSCH is also referred to as RRC configured CG.

In CG type 2 PUSCH, CG PUSCH transmission is activated or de-activated by DCI. Some parameters are configured by RRC such as periodicity and some power control parameters (i.e., alpha, P0, closed-loop index). Other parameters are indicated in the activation DCI, such as resource allocation, MCS, SRS resource indicator, precoding matrix and number of layers, PL-RS.

The Information Element (IE) ConfiguredGrantConfig in RRC is used to configure PUSCH transmission without dynamic grant according to CG type1 or CG type2. Multiple CG configurations may be configured in one BWP of a serving cell. Part of the ConfiguredGrantConfig IE is shown below:

ConfiguredGrantConfig information element

-- ASN1START
-- TAG-CONFIGUREDGRANTCONFIG-START

| ConfiguredGrantConfig ::= | SEQUENCE { | |
|---|---|---|
| frequencyHopping | ENUMERATED {intraSlot, interSlot} | OPTIONAL, -- |

Need S

| | |
|---|---|
| cg-DMRS-Configuration | DMRS-UplinkConfig, |
| mcs-Table | ENUMERATED {qam256, qam64LowSE} |

OPTIONAL, -- Need S

| | | |
|---|---|---|
| mcs-TableTransformPrecoder | ENUMERATED {qam256, qam64LowSE} | OPTIONAL, |

-- Need S

| | | |
|---|---|---|
| uci-OnPUSCH | SetupRelease { CG-UCI-OnPUSCH } | OPTIONAL, |

-- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| nrofHARQ-Processes | INTEGER(1..16), | |
|---|---|---|
| repK | ENUMERATED {n1, n2, n4, n8}, | |
| repK-RV | ENUMERATED {s1-0231, s2-0303, s3-0000} | OPTIONAL, |

-- Need R

| | |
|---|---|
| periodicity | ENUMERATED { |
| | sym2, sym7, sym1x14, sym2x14, sym4x14, sym5x14, sym8x14, |

sym10x14, sym16x14, sym20x14,

sym32x14, sym40x14, sym64x14, sym80x14, sym128x14,

sym160x14, sym256x14, sym320x14, sym512x14,

```
  sym640x14, sym1024x14, sym1280x14, sym2560x14, sym5120x14,
  sym6, sym1x12, sym2x12, sym4x12, sym5x12, sym8x12, sym 10x12,
```

sym16x12, sym20x12, sym32x12,

sym40x12, sym64x12, sym80x12, sym128x12, sym160x12,

sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1..maxNrofPhysicalResourceBlocks-1) |
| OPTIONAL, -- Need R | |
| pathlossReferenceIndex | INTEGER (0..maxNrofPUSCH-PathlossReferenceRSs- |

1),
...,

| | |
|---|---|
| } | OPTIONAL, -- Need R |

...,
}
-- TAG-CONFIGUREDGRANTCONFIG-STOP
-- ASN1STOP

Certain aspects of the disclosure and their embodiments may provide solutions to these or other challenges. Configured grant operation for unified TCI state framework has mainly been specified for sTRP operation in NR currently. How to support configured grant operation for unified TCI state framework to mTRP operation and the associated signaling details are still open problems that needs to be solved. In 3GPP, the discussions so far regarding UL transmission for FR2 has mainly been for a UE with single panel transmission (at each time instance). How to enable Simultaneous Transmission Across Multiple Panels (STxMP) is still an open issue, and some proposed methods to solve the issue for the new unified TCI state framework was disclosed in a previous application entitled “Framework for simultaneous multi-panel UL transmission.” As such, improved systems and methods for enabling transmission are needed.

### SUMMARY

Systems and methods for configured grant for multi-panel Uplink (UL) transmission are provided. In some embodiments, a method performed by a User Equipment (UE) for transmitting Physical Uplink Shared Channel (PUSCH) configured grant to multiple-Transmission Reception Points (TRPs) includes: receiving a configuration of at least one unified Transmission Configuration Indicator (TCI) state, indicating Multiple TRP (mTRP) operation; receiving an indication of a configured grant, indicating either mTRP operation using repetition or Simultaneous Transmission Across Multiple Panels (STxMP); and transmitting a PUSCH according to the configuration of unified TCI state and/or the configuration of configured grant. In this way, the unified TCI state framework can be extended to mTRP and multi-panel transmission for configured grant. With the unified TCI state framework, separate spatial relations do not have to be configured for UL transmission. Hence, unified TCI state framework can provide some higher layer overhead savings. By extending unified TCI state framework for mTRP and multi-panel transmission for configured grant, configured grant based PUSCH can also leverage this advantage.

In some embodiments, a method performed by a network node for receiving a PUSCH configured grant includes: transmitting, to a UE, a configuration of at least one unified TCI state, indicating mTRP operation; transmitting, to the UE, an indication of a configured grant, indicating either mTRP operation using repetition or STxMP; and receiving, from the UE, a PUSCH according to the configuration of unified TCI state and/or the configuration of configured grant.

In some embodiments, the received configuration comprises at least two unified TCI states.

In some embodiments, the received configuration of the at least one unified TCI state indicates UL transmission to two TRPs.

In some embodiments, the received configuration for the at least one unified TCI state indicates UL transmission to two TRPs by applying two Joint/UL TCI states.

In some embodiments, the indication explicitly indicates mTRP operation using either STxMP or repetition. In some embodiments, the indication of mTRP operation using either repetition or STxMP is conveyed through one of the group consisting of: RRC signaling; and DCI.

In some embodiments, the indication of the configured grant comprises a single CG PUSCH configuration which is associated with a first and a second common beam using STxMP. In some embodiments, there is an association between a coresetPoolIndex and a CG-PUSCH.

In some embodiments, other indication of mTRP operation using repetition for configured grant is ignored by the UE. In some embodiments, the UE ignores the configuration of one or both of the parameters “p0-PUSCH-Alpha” and “powerControlLoopToUse” as configured in ConfiguredGrantConfig IE.

In some embodiments, the explicit indication is configured in a new field in ConfiguredGrantConfig IE.

In some embodiments, the explicit indication is indicated in a field in UL DCI where one codepoint indicates mTRP operation using repetition, and one codepoint indicates mTRP operation using STxMP.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a two-step procedure related to Transmission Configuration Indicator (TCI) state update;

FIG. 2 illustrates the structure of the Medium Access Control (MAC) Control Element (CE) for activating/deactivating TCI states for User Equipment (UE) specific Physical Downlink Shared Channel (PDSCH);

FIG. 3 illustrates one example of a Downlink Control Information (DCI) indication of a TCI state;

FIG. 4 illustrates a MAC Protocol Data Unit (PDU) subheader with extended Logical Channel ID (eLCID);

FIG. 5 illustrates an example of Physical Uplink Control Channel (PUCCH)/Physical Uplink Shared Channel (PUSCH) transmission towards multiple Transmission Reception Points (TRPs) for increasing reliability;

FIG. 6 illustrates an example of a single DCI triggered PUCCH repetitions each towards a different TRP;

FIG. 7 illustrates an example PUSCH repetitions each towards a different TRP;

FIG. 8 shows an example of a communication system in accordance with some embodiments;

FIG. 9 shows a UE in accordance with some embodiments;

FIG. 10 shows a network node in accordance with some embodiments;

FIG. 11 is a block diagram of a host, which may be an embodiment of the host of FIG. 8, in accordance with various aspects described herein;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

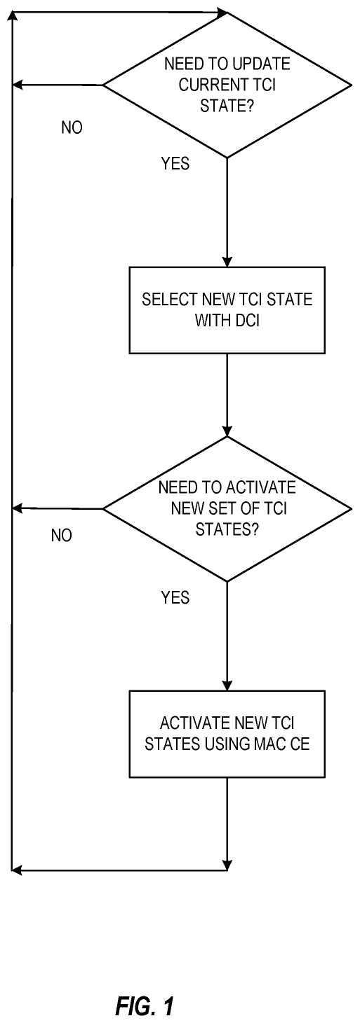

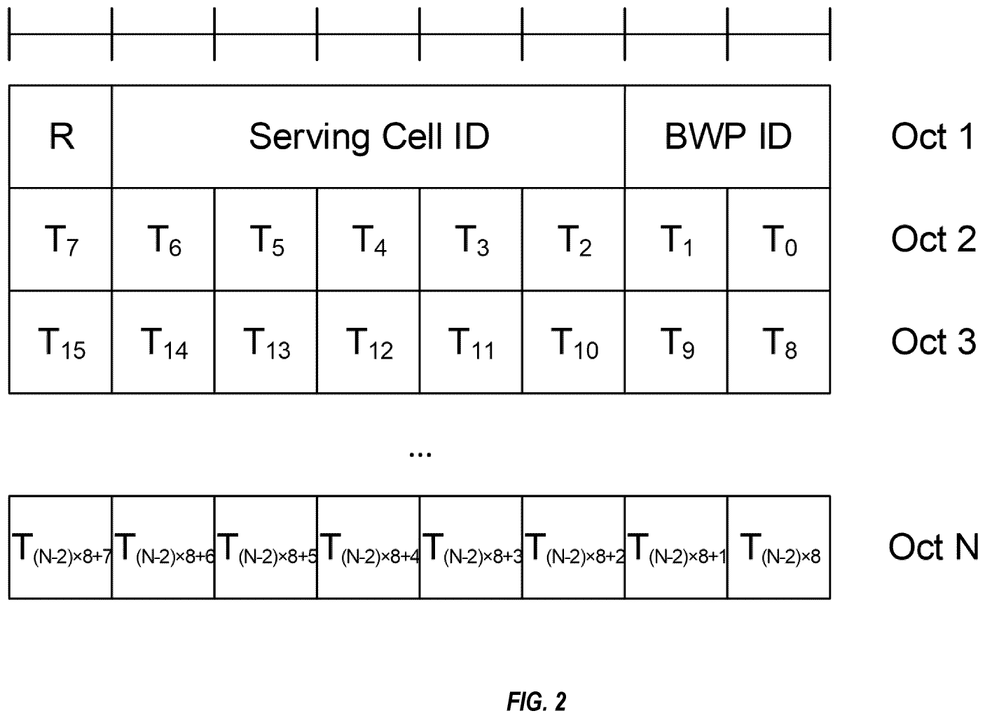

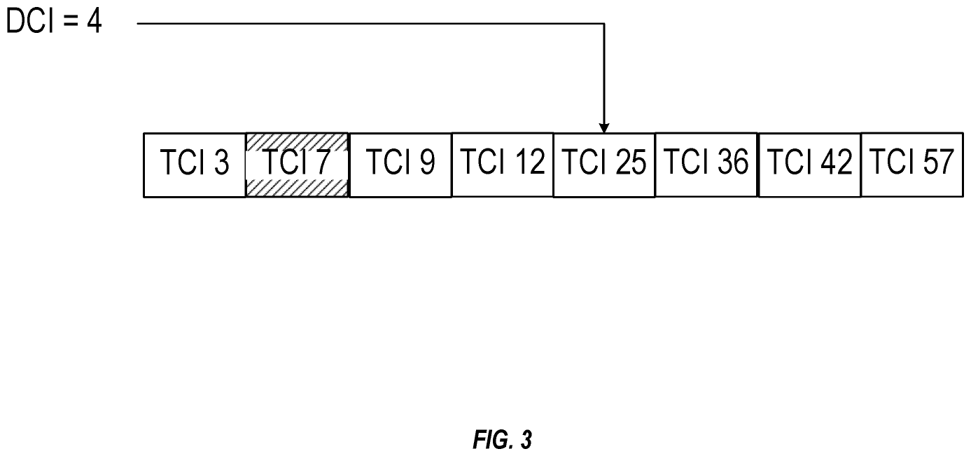

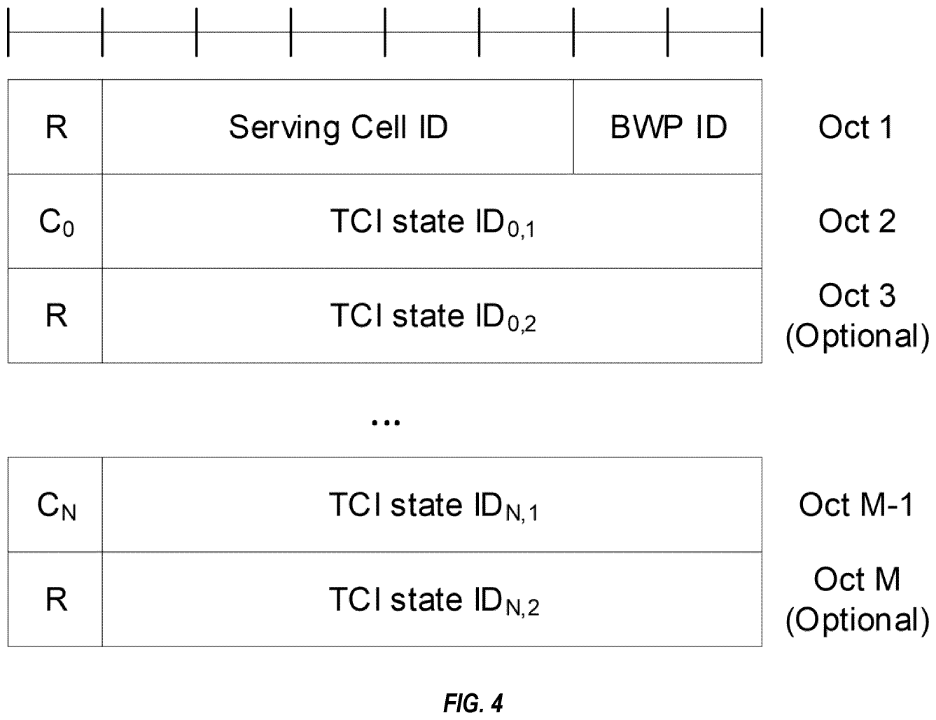

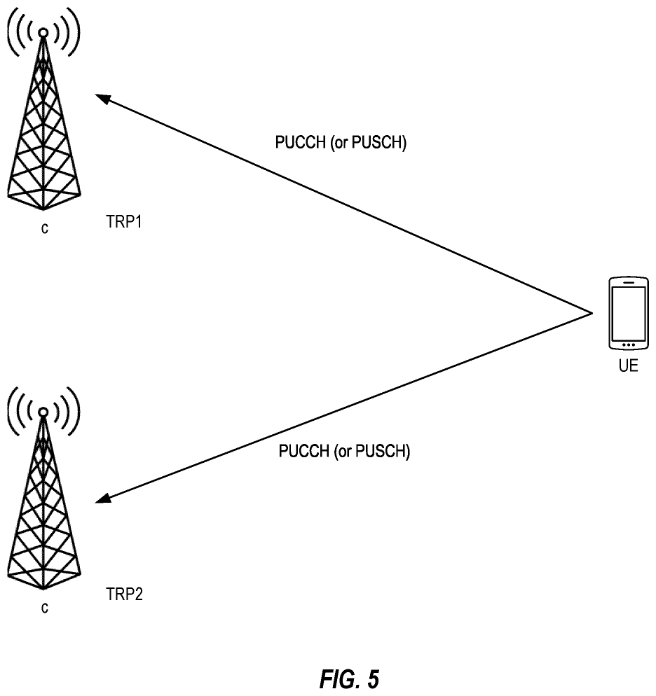

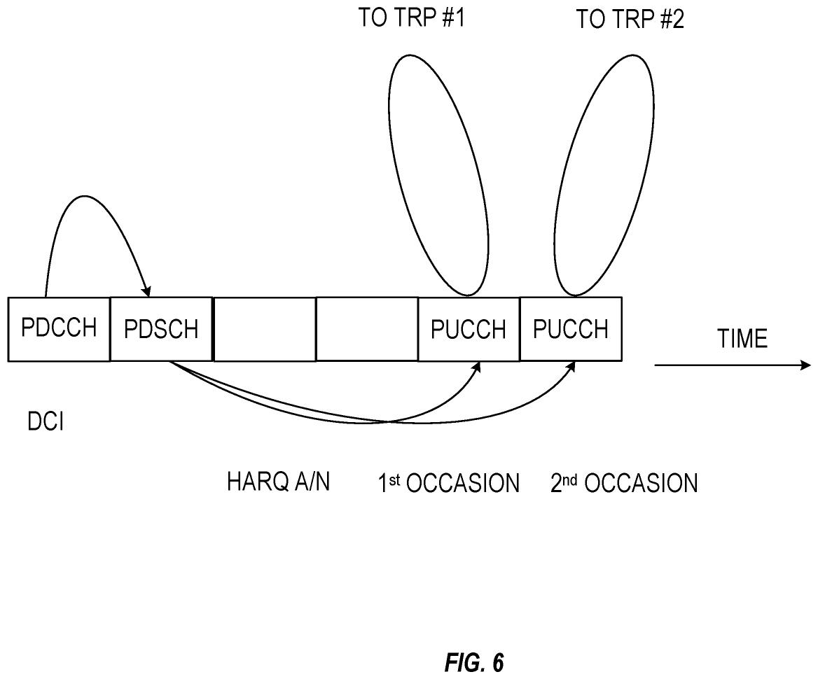

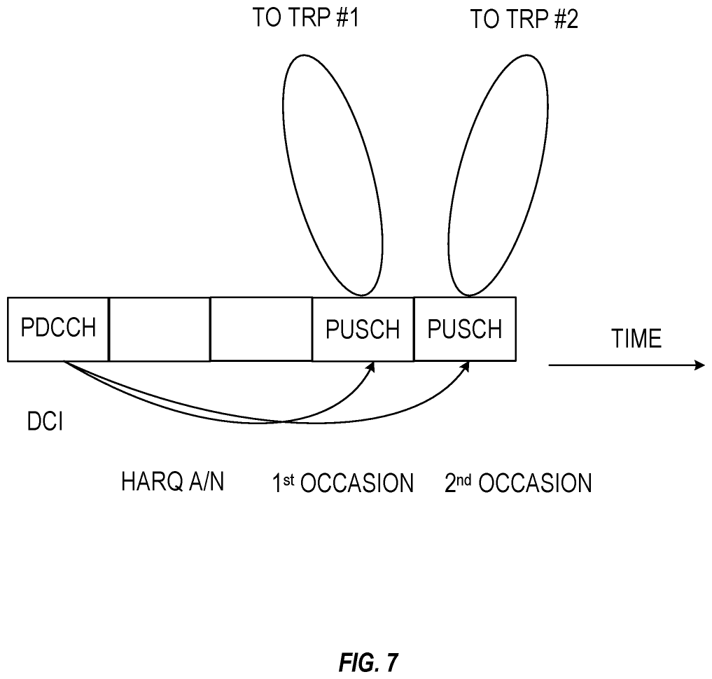

### DETAILED DESCRIPTION

The embodiments set forth below represent information to enable those skilled in the art to practice the embodiments and illustrate the best mode of practicing the embodiments.

Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

Some embodiments herein include a signaling framework to support configured grant mTRP operation (both for repetition and STxMP) for unified TCI state framework.

Certain embodiments may provide one or more of the following technical advantage(s). In some embodiments, a method in a UE for transmitting PUSCH configured grant to multiple-TRPs using the unified TCI state framework, includes one or more of: receiving configuration of unified TCI state framework, indicating mTRP operation; receiving indication of a configured grant, indicating either mTRP operation using repetition or STxMP; and transmitting PUSCH according to the configuration of unified TCI state and the configuration of configured grant.

In some embodiments, the received configuration for the unified TCI state framework indicates UL transmission to two TRPs (by for example applying two Joint/UL TCI states). In some embodiments, the indication explicitly indicates mTRP operation using either STxMP or repetition. In some embodiments, the indicating of mTRP operation using either repetition or STxMP is conveyed through RRC signaling. In some embodiments, the indicating of mTRP operation using either repetition or STxMP is conveyed through DCI.

In some embodiments, other indication of mTRP operation using repetition for configured grant is ignored by the UE. In some embodiments, the UE ignores the configuration of one or both of the parameters “p0-PUSCH-Alpha” and “powerControlLoopToUse” as configured in ConfiguredGrantConfig IE as specified in TS 38.331. In some embodiments, the explicit indication (of either mTRP operation using repetition or STxMP) is configured in a new bitfield in ConfiguredGrantConfig IE as specified in TS 38.331. In some embodiments, the explicit indication (of either mTRP operation using repetition or STxMP) is indicated in a bitfield in UL DCI where one codepoint indicates mTRP operation using repetition, and one codepoint indicates mTRP operation using STxMP.

With the proposed solutions, the unified TCI state framework can be extended to mTRP and multi-panel transmission for configured grant. With the unified TCI state framework, separate spatial relations do not have to be configured for UL transmission. Hence, unified TCI state framework can provide some higher layer overhead savings. By extending unified TCI state framework for mTRP and multi-panel transmission for configured grant, configured grant based PUSCH can also leverage this advantage.

Single CG is Used for Both sTRP and mTRP (STxMP and Repetition) Transmission

In one embodiment, for type 1 CG PUSCH, a new bitfield is introduced in ConfiguredGranConfig IE as specified in TS 38.331, where the new bitfield indicates whether the UE shall perform CG based mTRP PUSCH repetition or CG based mTRP PUSCH simultaneous transmission over multiple panels (STxMP) in case the UE is indicated with mTRP UL transmission (for example if the UE is configured with two applied Joint/UL TCI states). Note that when a joint TCI state or UL TCI state is updated via a DCI, the joint TCI state or UL TCI state is the applied Joint TCI state or UL TCI state. When two joint TCI states or UL TCI states are updated via a DCI, the joint TCI states or UL TCI states are the applied Joint TCI states or UL TCI states. One schematic example of how this could look can be found in the table below. Here a new parameter (here referred to as “mTRP-transmission-Type”) is introduced. If the parameter “mTRP-transmission-Type” is configured to STxMP, the UE should apply mTRP STxMP PUSCH transmission when configured for mTRP UL transmission for the configured grant. If the parameter “mTRP-transmission-Type” is configured for mTRP PUSCH repetition (either within a slot or over multiple slots), then the UE should perform mTRP PUSCH repetition (either within a slot or over multiple slots) when configured for mTRP UL transmission for the configured grant.

ConfiguredGrantConfig information element

| -- ASN1START | |
|---|---|
| -- TAG-CONFIGUREDGRANTCONFIG-START | |
| ConfiguredGrantConfig ::= SEQUENCE { | |
| ...[ | |
| mTRP-transmission-Type | ENUMERATED {STxMP} |

...[
},

In another embodiment, the ‘mTRP-transmission-Type’ parameter shown in the example above is optionally configured to the UE. A new UE behavior is defined based on the optional configuration of the ‘mTRP-transmission-Type’ parameter. If the optional parameter ‘mTRP-transmission-Type’ is configured (for instance, the parameter is set to ‘STxMP’), then the UE applies mTRP STxMP PUSCH transmission when configured for mTRP UL transmission for the configured grant. If the optional parameter ‘mTRP-transmission-Type’ is not configured, then the UE performs mTRP PUSCH repetition (either within a slot or over multiple slots) when configured for mTRP UL transmission for the configured grant.

In another variant of the above embodiment, if the optional parameter ‘mTRP-transmission-Type’ is configured (for instance, the parameter is set to ‘STxMP’), then the UE applies mTRP STxMP PUSCH transmission when configured for mTRP UL transmission for the configured grant. If the optional parameter ‘mTRP-transmission-Type’ is not configured, then the UE performs PUSCH transmission to a single TRP for configured grant. This single TRP PUSCH transmission may consist of ether a single repetition or multiple repetitions depending on the number of repetitions configured as part of the ConfiguredGrantConfig configuration in 3GPP TS 38.331. Note that for the single TRP PUSCH transmission, the spatial transmit filter used is provided by a single SRI configured in the configured grant (i.e., srs-ResourceIndicator configured as part of the ConfiguredGrantConfig information element in 3GPP TS 38.331).

In one embodiment, a UE with two Joint/UL TCI states applied and where the UE is configured with a type 2 CG, a new (or old re-purposed) bitfield in a UL DCI is used to indicate whether the UE shall perform CG based mTRP PUSCH repetition or CG based mTRP PUSCH STxMP. In one alternate of this embodiment, the new bitfield can also be used to indicate if CG based sTRP PUSCH transmission should be performed (and if so, to which TRP). In one alternate of this embodiment, the new bitfield introduced for UL DCI in Rel-17 to indicate sTRP or mTRP PUSCH repetition is extended or re-purposed such that at least one codepoint in this bitfield is used to indicate CG based mTRP PUSCH STxMP. Two schematic examples of how this bitfield could look are illustrated below:

| Codepoint | Operation |
|---|---|
| 00 | s-TRP mode with TRP1 |
| 01 | s-TRP mode with 2^{nd} TRP2 |
| 10 | m-TRP mode with repetition |
| 11 | m-TRP mode with STxMP |
| 000 | s-TRP mode with TRP1 |
| 001 | s-TRP mode with 2^{nd} TRP2 |
| 010 | m-TRP mode with (TRP1, TRP2 order) |
| 011 | m-TRP mode with (TRP2, TRP1 order) |
| 100 | m-TRP mode with STxMP |

For simultaneous PUSCH transmission by a UE to multiple TRPs, the transmission to multi-TRPs may share the same time/frequency resource, referring here as Spatial Division Multiplexing (SDM), or use different frequency domain resources for different TRPs, referring here as Frequency Division Multiplexing (FDM). Therefore, the CG configuration may also indicate whether SDM or FDM is used.

Different data may be sent to different TRPs and may be associated with a single or multiple Transport Blocks (TBs). In case of a single TB, the TB would be encoded in a single Codeword (CW) and allocated with a single MCS. In case of multiple TBs, they would be encoded in different CWs, one for each TRP. Each of the CWs may have different number of layers and different MCS. Therefore, the CG configuration may also indicate whether SDM or FDM is used and additionally, whether a single TB or multiple TBs are used. Alternatively, whether a single TB or multiple TBs are pre-determined by specification. In case of multiple TBs, a separate MCS per CW may be configured as part of the CG configuration.

For PUSCH transmission to multiple TRPs, a TRP may be represent by a unified TCI state or a UL TCI state. As such, multiple unified TCI states or UL TCI states may be configured for each CG PUSCH. A precoding matrix with a number of layers (in case of codebook based PUSCH) and a set of power control parameters may be configured for each TRP.

In some embodiments, a precoding matrix with a number of layers (in case of codebook based PUSCH) and/or a set of power control parameters may be configured as part of each unified TCI state or UL TCI state. When the multiple unified TCI states or UL TCI states are configured for each CG PUSCH, then the precoding matrix with a number of layers and/or the set of power control parameters configured in the multiple unified TCI states or UL TCI states will be used for CG PUSCH transmission.

In case of SDM, different DMRS ports would be allocated for PUSCH transmission to different TRPs. The DMRS ports may be allocated together, e.g., DMRS ports {x, y, z}, and the association of the ports to each TRP may be identified by the number of layers associated with each TRP. For example, if one layer is allocated to a first TRP and two layers are allocated to the second TRP, then DMRS port x is associated with the first TRP while DMRS ports {y, z} are associated with the second TRP.

In case of FDM, the same DMS port(s) may be used for PUSCH transmission to both TRPs. A single frequency domain resource may be allocated, and an implicit rule may be used to partition the resource among multiple TRPs. For example, in case of two TRPs and if N RBs are allocated, the first ┌N/2┐ RBs may be allocated to the first TRP while the remaining PRBs are allocated to the second TRP. In another example, in case of two TRPs and if N RBs are allocated, then the odd RBs may be allocated to the first TRP while the even RBs are allocated to the second TRP.

For PUSCH transmission, the UE Tx antennas or panels are defined by SRS resources. To transmit PUSCH simultaneously with two panels, the corresponding two SRS resources need to be indicated to the UE. It should be noted that when the UE is configured/indicated with multiple UL TCI states or joint TCI states for CG PUSCH transmission, the transmit spatial filters for the CG PUSCH transmission are provided by the UL TCI states or the joint TCI states. The spatial relations associated with the SRS resources, if configured, in this embodiment do not provide the transmit spatial filters for the CG PUSCH transmission. However, the SRS resources are used by the UE to determine the antenna ports with which CG PUSCH is transmitted.

In summary, for CG PUSCH with STxMP to two TRPs, one of more of the following additional fields may be configured under ConfiguredGrantConfig as shown below (Additional fields to configure CG PUSCH):

ConfiguredGrantConfig information element

-- ASN1START
-- TAG-CONFIGUREDGRANTCONFIG-START

| | |
|---|---|
| ConfiguredGrantConfig ::= | SEQUENCE { |

...

| | |
|---|---|
| SDM-or-FDM | ENUMERATED {SDM, FDM} |
| second_powerControlLoopToUse | ENUMERATED {n0, |

n1}

| | |
|---|---|
| Second_p0-PUSCH-Alpha | P0-PUSCH- |

AlphaSetId

| | |
|---|---|
| rrc-ConfiguredUplinkGrant | SEQUENCE { |
| first-UL-TCI-State | INTEGER (0..maxNrof-UL-TCI- |

Sates)

| | |
|---|---|
| second-UL-TCI-State | INTEGER (0..maxNrof-UL-TCI- |

Sates)

| | |
|---|---|
| second-precodingAndNumberOfLayers | INTEGER (0..63) |
| second-srs-ResourceIndicator | INTEGER (0..15) |

OPTIONAL, -- Need R

| | |
|---|---|
| second-mcsAndTBS | INTEGER (0..31) |

```
  OPTIONAL, -- Need R
        ...
        }
  }
  ...
-- TAG-CONFIGUREDGRANTCONFIG-STOP
-- ASN1STOP
```

Multiple CGs are Used for mTRP (STxMP and/or Repetition) Transmission

In one embodiment, a CG can be associated to one or multiple common beams through RRC signaling. In a detailed embodiment, a new RRC field is included in ConfiguredGrantConfig IE as specified in TS 38.331, where the new field can indicate which common beam(s) the CG should be associated with. The new field consist of several codepoints, where each codepoint is associated to one option, and where the candidate options for example can be one or more of:
CG PUSCH is associated to a first common beam
CG PUSCH is associated with a second common beam
CG PUSCH is associated with a first and a second common beam using repetition

In the above example, when a CG PUSCH is associated with a single common beam (either first common beam or second common beam), CG PUSCH is transmitted towards a single TRP. When a CG PUSCH is associated with two common beams, CG PUSCH is transmitted towards two TRPs. Note that the common beams in the above examples may be derived from UL TCI states or joint TCI states wherein one common beam is derived from a single UL TCI state or joint TCI state. One common beam is essentially a spatial filter used to transmit the CG PUSCH that is derived from a single UL TCI state or joint TCI state. In one specific example, to associate CG PUSCH with a single common beam, a single UL TCI state or joint TCI state is mapped to one codepoint of the RRC field. Similarly, to associated CG PUSCH with two common beams, two UL TCI states or joint TCI states are mapped to one codepoint of the RRC

### FIELD

In one embodiment, STxMP can be configured for a UE by configuring the UE with two different CGs, and where one CG is associated to a first common beam and the second CG is associated with a second common beam (STxMP will occur in case the PUSCH time allocations for the two CGs are at least partly overlapping).

In another embodiment, STxMP can be configured for a UE by configuring the UE with a single CG PUSCH configuration. In this case, the CG PUSCH is associated with a first and a second common beam using STxMP.

In one embodiment, for mDCI based mTRP operation for the unified TCI state framework, it might be so that a coresetPoolIndex is associated with a common beam index (or associated with an applied Joint/UL TCI state). In this case, there might be an association between a coresetPoolIndex and a CG. In one detailed embodiment, a new field is included in ConfiguredGrantConfig IE which is used to indicate the association to a coresetPoolIndex. In another detailed embodiment, the association between a configured grant and a coresetPoolIndex is indicated through a new information element.

In some embodiments, when the UE is configured with the unified TCI state framework the UE should ignore the power control parameter(s) “p0-PUSCH-Alpha” and “powerControlLoopToUse” as configured in ConfiguredGrantConfig IE as specified in TS 38.331. Instead, the UE should use the power control parameters associated with the unified TCI state framework for configured grant PUSCH transmission.

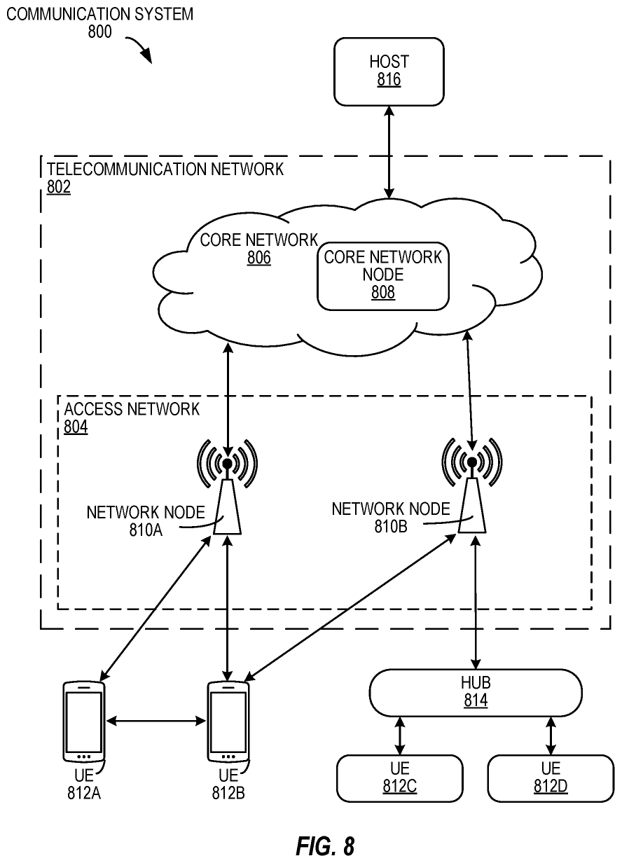

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access node or non-3GPP Access Point (AP). The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and the network node 810B, but which is additionally capable of operating as a communication start and/or end point for certain data channels.

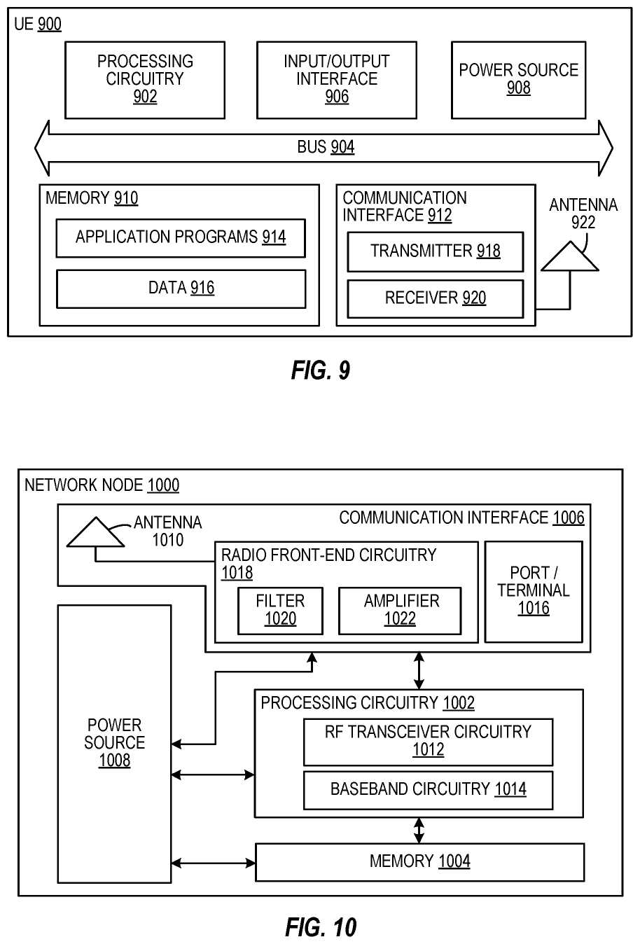

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple

Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

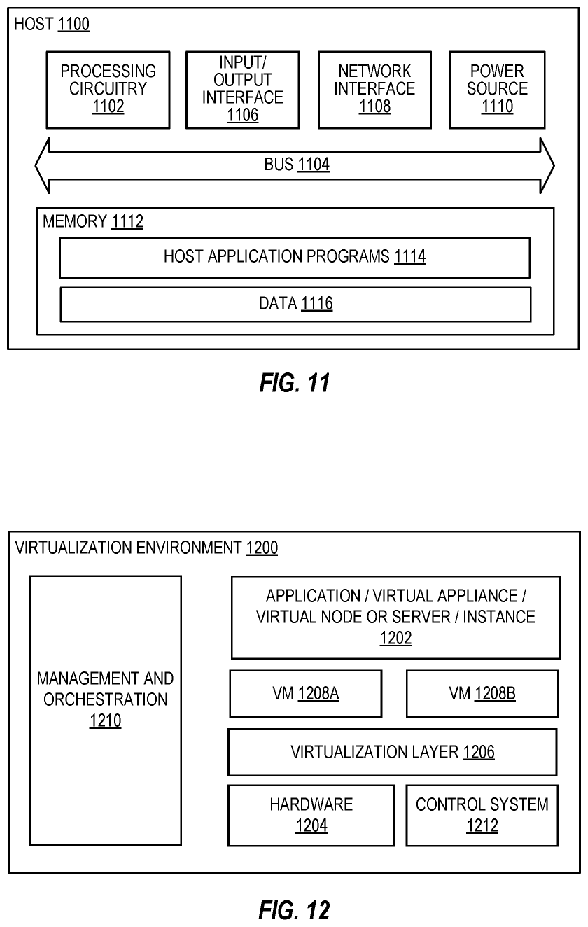

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g. data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

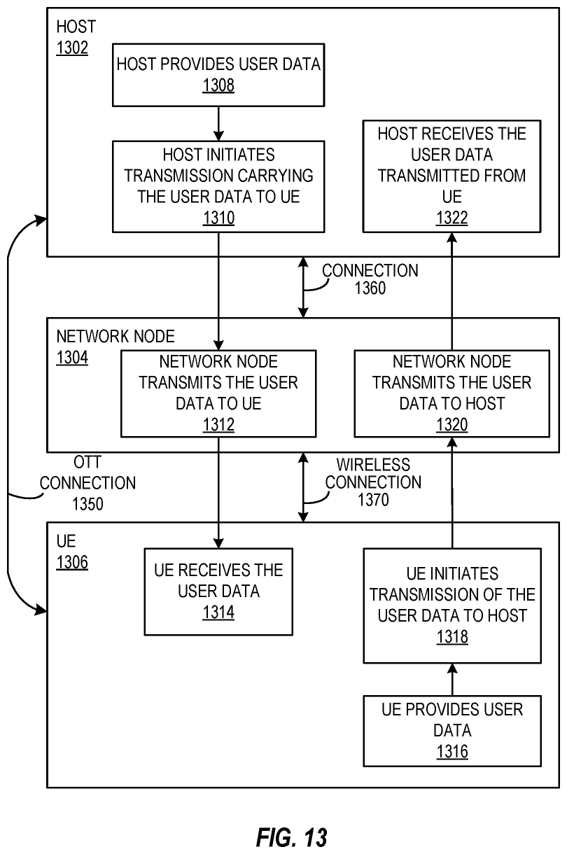

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a

UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein.

Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

### Group A Embodiments

Embodiment 1: A method performed by a user equipment, UE, for transmitting

PUSCH configured grant to multiple-TRPs, the method comprising one or more of: a. receiving configuration of unified TCI state framework, indicating mTRP operation; b. receiving indication of a configured grant, indicating either mTRP operation using repetition or STxMP; and c. transmitting PUSCH according to the configuration of unified TCI state and/or the configuration of configured grant.

Embodiment 2: The method of any of the previous embodiments wherein the received configuration for the unified TCI state framework indicates UL transmission to two TRPs.

Embodiment 3: The method of any of the previous embodiments wherein the received configuration for the unified TCI state framework indicates UL transmission to two TRPs by applying two Joint/UL TCI states.

Embodiment 4: The method of any of the previous embodiments wherein the indication explicitly indicates mTRP operation using either STxMP or repetition.

Embodiment 5: The method of any of the previous embodiments wherein the indication of mTRP operation using either repetition or STxMP is conveyed through RRC signaling.

Embodiment 6: The method of any of the previous embodiments wherein the indication of mTRP operation using either repetition or STxMP is conveyed through DCI.

Embodiment 7: The method of any of the previous embodiments wherein other indication of mTRP operation using repetition for configured grant is ignored by the UE.

Embodiment 8: The method of any of the previous embodiments wherein the UE ignores the configuration of one or both of the parameters “p0-PUSCH-Alpha” and “powerControlLoopToUse” as configured in ConfiguredGrantConfig IE as specified in TS 38.331.

Embodiment 9: The method of any of the previous embodiments wherein the explicit indication (of either mTRP operation using repetition or STxMP) is configured in a new bitfield in ConfiguredGrantConfig IE as specified in TS 38.331.

Embodiment 10: The method of any of the previous embodiments wherein the explicit indication (of either mTRP operation using repetition or STxMP) is indicate in a bitfield in UL DCI where one codepoint indicates mTRP operation using repetition, and one codepoint indicates mTRP operation using STxMP.

Embodiment 11: The method of any of the previous embodiments, further comprising: providing user data; and forwarding the user data to a host via the transmission to the network node.

### Group B Embodiments

Embodiment 12: A method performed by a network node for receiving PUSCH configured grant, the method comprising one or more of: a. transmitting configuration of unified TCI state framework, indicating mTRP operation; b. transmitting indication of a configured grant, indicating either mTRP operation using repetition or STxMP; and c. transmitting PUSCH according to the configuration of unified TCI state and/or the configuration of configured grant.

Embodiment 13: The method of any of the previous embodiments wherein the transmitted configuration for the unified TCI state framework indicates UL transmission to two TRPs.

Embodiment 14: The method of any of the previous embodiments wherein the transmitted configuration for the unified TCI state framework indicates UL transmission to two TRPs by applying two Joint/UL TCI states.

Embodiment 15: The method of any of the previous embodiments wherein the indication explicitly indicates mTRP operation using either STxMP or repetition.

Embodiment 16: The method of any of the previous embodiments wherein the indication of mTRP operation using either repetition or STxMP is conveyed through RRC signaling.

Embodiment 17: The method of any of the previous embodiments wherein the indication of mTRP operation using either repetition or STxMP is conveyed through DCI.

Embodiment 18: The method of any of the previous embodiments wherein other indication of mTRP operation using repetition for configured grant is ignored by the UE.

Embodiment 19: The method of any of the previous embodiments wherein the UE ignores the configuration of one or both of the parameters “p0-PUSCH-Alpha” and “powerControlLoopToUse” as configured in ConfiguredGrantConfig IE as specified in TS 38.331.

Embodiment 20: The method of any of the previous embodiments wherein the explicit indication (of either mTRP operation using repetition or STxMP) is configured in a new bitfield in ConfiguredGrantConfig IE as specified in TS 38.331.

Embodiment 21: The method of any of the previous embodiments wherein the explicit indication (of either mTRP operation using repetition or STxMP) is indicate in a bitfield in UL DCI where one codepoint indicates mTRP operation using repetition, and one codepoint indicates mTRP operation using STxMP.

Embodiment 22: The method of any of the previous embodiments, further comprising: obtaining user data; and forwarding the user data to a host or a user equipment.

### Group C Embodiments

Embodiment 23: A user equipment for transmitting PUSCH configured grant to multiple-TRPs, comprising: processing circuitry configured to perform any of the steps of any of the Group A embodiments; and power supply circuitry configured to supply power to the processing circuitry.

Embodiment 24: A network node for receiving PUSCH configured grant, the network node comprising: processing circuitry configured to perform any of the steps of any of the Group B embodiments; power supply circuitry configured to supply power to the processing circuitry.

Embodiment 25: A user equipment (UE) for transmitting PUSCH configured grant to multiple-TRPs, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 26: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 27: The host of the previous embodiment, wherein the cellular network further includes a network node configured to communicate with the UE to transmit the user data to the UE from the host.

Embodiment 28: The host of the previous 2 embodiments, wherein: the processing circuitry of the host is configured to execute a host application, thereby providing the user data; and the host application is configured to interact with a client application executing on the UE, the client application being associated with the host application.

Embodiment 29: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 30: The method of the previous embodiment, further comprising: at the host, executing a host application associated with a client application executing on the UE to receive the user data from the UE.

Embodiment 31: The method of the previous embodiment, further comprising: at the host, transmitting input data to the client application executing on the UE, the input data being provided by executing the host application, wherein the user data is provided by the client application in response to the input data from the host application.

Embodiment 32: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 33: The host of the previous embodiment, wherein the cellular network further includes a network node configured to communicate with the UE to transmit the user data from the UE to the host.

Embodiment 34: The host of the previous 2 embodiments, wherein: the processing circuitry of the host is configured to execute a host application, thereby providing the user data; and the host application is configured to interact with a client application executing on the UE, the client application being associated with the host application.

Embodiment 35: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 36: The method of the previous embodiment, further comprising: at the host, executing a host application associated with a client application executing on the UE to receive the user data from the UE.

Embodiment 37: The method of the previous embodiment, further comprising: at the host, transmitting input data to the client application executing on the UE, the input data being provided by executing the host application, wherein the user data is provided by the client application in response to the input data from the host application.

Embodiment 38: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 39: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 40: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 41: The method of the previous embodiment, further comprising, at the network node, transmitting the user data provided by the host for the UE.

Embodiment 42: The method of any of the previous 2 embodiments, wherein the user data is provided at the host by executing a host application that interacts with a client application executing on the UE, the client application being associated with the host application.

Embodiment 43: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 44: The communication system of the previous embodiment, further comprising: the network node; and/or the user equipment.

Embodiment 45: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 46: The host of the previous 2 embodiments, wherein: the processing circuitry of the host is configured to execute a host application, thereby providing the user data; and the host application is configured to interact with a client application executing on the UE, the client application being associated with the host application.

Embodiment 47: The host of the any of the previous 2 embodiments, wherein the initiating receipt of the user data comprises requesting the user data.

Embodiment 48: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 49: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function.
AN Access Network
AP Access Point
ASIC Application Specific Integrated Circuit
AUSF Authentication Server Function
CG Configured Grant
CPU Central Processing Unit
DCI Downlink Control Information
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
Information Element
IoT Internet of Things
IP Internet Protocol
LTE Long Term Evolution
MME Mobility Management Entity
MTC Machine Type Communication
mTRP Multiple Transmission Reception Point
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
PUSCH Physical Uplink Shared Channel
QoS Quality of Service
RAM Random Access Memory
RAN Radio Access Network
ROM Read Only Memory
RRC Radio Resource Control
RRH Remote Radio Head
RTT Round Trip Time
SCEF Service Capability Exposure Function
SMF Session Management Function
STxMP Simultaneous Transmission Across Multiple Panels
TCI Transmission Configuration Indicator
TRP Transmission Reception Point
UDM Unified Data Management
UE User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for transmitting a Physical Uplink Shared Channel, PUSCH, configured grant to multiple-Transmission Reception Points, TRPs, the method comprising:
receiving a configuration of at least one unified Transmission Configuration Indicator, TCI, state, indicating Multiple TRP, mTRP, operation;
receiving an indication of a configured grant, CG, indicating either mTRP operation using repetition or Simultaneous Transmission Across Multiple Panels, STxMP; and
transmitting a PUSCH according to the configuration of unified TCI state and/or the configuration of the configured grant;
where a ConfiguredGrantConfig Information Element, IE, can be Radio Resource Control, RRC, configured with a new field indicating one or more of:
following a first common beam;
following a second common beam; and
following both a first and a second common beam.

2. (canceled)

3. (canceled)

4. The method of claim 1 wherein the indication explicitly indicates mTRP operation using either STxMP or repetition.

5. The method of claim 1 wherein the indication of mTRP operation using either repetition or STxMP is conveyed through Radio Resource Control, RRC, signaling.

6. (canceled)

7. The method of claim 1 wherein the indication of the configured grant comprises a single CG PUSCH configuration which is associated with a first and a second common beam using STxMP.

8. The method of claim 1 wherein there is an association between a coresetPoolIndex and a CG-PUSCH.

9. (canceled)

10. The method of claim 1 wherein the UE ignores the configuration of one or both of the parameters “p0-PUSCH-Alpha” and “powerControlLoopToUse” as configured in ConfiguredGrantConfig Information Element, IE.

11. (canceled)

12. (canceled)

13. (canceled)

14. A method performed by a network node for receiving a Physical Uplink Shared Channel, PUSCH, configured grant, CG, the method comprising:
transmitting, to a User Equipment, UE, a configuration of at least one unified Transmission Configuration Indicator, TCI, state, indicating multiple Transmission Reception Points, mTRP, operation;
transmitting, to the UE, an indication of a configured grant, indicating either mTRP operation using repetition or Simultaneous Transmission Across Multiple Panels, STxMP; and
receiving, from the UE, a PUSCH according to the configuration of unified TCI state and/or the configuration of the configured grant;
where a ConfiguredGrantConfig Information Element, IE, can be Radio Resource Control, RRC, configured with a new field indicating one or more of:
following a first common beam;
following a second common beam; and
following both a first and a second common beam.

15. (canceled)

16. (canceled)

17. The method of claim 14 wherein the indication explicitly indicates mTRP operation using either STxMP or repetition.

18. The method of claim 14 wherein the indication of mTRP operation using either repetition or STxMP is conveyed through Radio Resource Control, RRC.

19. (canceled)

20. The method of claim 14 wherein the indication of the configured grant comprises a single CG PUSCH configuration which is associated with a first and a second common beam using STxMP.

21. The method of claim 14 wherein there is an association between a coresetPoolIndex and a CG-PUSCH.

22. (canceled)

23. The method of claim 14 wherein the UE ignores the configuration of one or both of the parameters “p0-PUSCH-Alpha” and “powerControlLoopToUse” as configured in ConfiguredGrantConfig Information Element, IE.

24. (canceled)

25. (canceled)

26. A User Equipment, UE, for transmitting Physical Uplink Shared Channel, PUSCH, configured grant, CG, to multiple-Transmission Reception Points, TRPs, comprising processing circuitry configured to cause the UE to:
receive a configuration of at least one unified Transmission Configuration Indicator, TCI, state, indicating Multiple TRP, mTRP, operation;
receive an indication of a configured grant, indicating either mTRP operation using repetition or Simultaneous Transmission Across Multiple Panels, STxMP; and
transmit a PUSCH according to the configuration of unified TCI state and/or the configuration of the configured grant;
where a ConfiguredGrantConfig Information Element, IE, can be Radio Resource Control, RRC, configured with a new field indicating one or more of:
following a first common beam;
following a second common beam; and
following both a first and a second common beam.

27. (canceled)

28. A network node for receiving a Physical Uplink Shared Channel, PUSCH, configured grant, CG, comprising processing circuitry configured to cause the network node to:
transmit, to a User Equipment, UE, a configuration of at least one unified Transmission Configuration Indicator, TCI, state, indicating multiple Transmission Reception Points, mTRP, operation;
transmit, to the UE, an indication of a configured grant, indicating either mTRP operation using repetition or Simultaneous Transmission Across Multiple Panels, STxMP; and
receive, from the UE, a PUSCH according to the configuration of unified TCI state and/or the configuration of the configured grant;
where a ConfiguredGrantConfig Information Element, IE, can be Radio Resource Control, RRC, configured with a new field indicating one or more of:
following a first common beam;
following a second common beam; and
following both a first and a second common beam.

29. (canceled)

30. The method of claim 1, wherein the first common beam is a first activated joint or uplink TCI state and the second common beam is a second activated joint or uplink TCI state.

31. The method of claim 14, wherein the first common beam is a first activated joint or uplink TCI state and the second common beam is a second activated joint or uplink TCI state.

32. The UE of claim 26, wherein the first common beam is a first activated joint or uplink TCI state and the second common beam is a second activated joint or uplink TCI state.

33. The network node of claim 28, wherein the first common beam is a first activated joint or uplink TCI state and the second common beam is a second activated joint or uplink TCI state.
